(19) United States
(12) Patent Application Publication
(10) Pub. No.: US 2014/0274216 A1
(43) Pub. Date: Sep. 18, 2014

(54) MOBILE COMMUNICATION DEVICE

(71) Applicant: OnBeond, LLC, Santa Monica, CA (US)

(72) Inventor: Robert Olodort, Santa Monica, CA (US)

(73) Assignee: OnBeond, LLC, Santa Monica, CA (US)

(21) Appl. No.: 14/212,786

(22) Filed: Mar. 14, 2014

Related U.S. Application Data
(60) Provisional application No. 61/792,536, filed on Mar. 15, 2013.
(60) Provisional application No. 61/842,277, filed on Jul. 2, 2013.
(60) Provisional application No. 61/842,901, filed on Jul. 3, 2013.

(51) Int. Cl. H04W 4/16; H04W 52/02; H04M 19/08; H04M 1/00; H04M 1/02

(52) U.S. Cl. CPC H04W 4/16; H04M 1/006; H04M 1/0202; H04M 19/08; H04W 52/0261
USPC 455/566; 455/417

(57) ABSTRACT

Various embodiments of a cellular telephone are described, including embodiments having no external physical buttons and no external physical switches. In one embodiment, the device is small enough to fit in a small pocket yet has a touchscreen large enough for a smartphone-sized virtual keyboard. In one embodiment, the device automatically switches between various power modes configurations and can send at least one notification to a user when its battery needs charging. Each described embodiment of a cellular telephone can be used as a primary cellular device or a secondary cellular device, where the secondary cellular device can share the same cellular number as that of the primary cellular device.

This application claims the benefit, including the benefit of the filing dates, of the following U.S. Provisional Patent Applications: 61/792,536 (filed Mar. 15, 2013); 61/842,277 (filed Jul. 2, 2013); and 61/842,901 (filed Jul. 3, 2013) and all three of these provisional applications are incorporated herein by reference in their entirety.

### BACKGROUND OF THE INVENTION

Since the infancy of the cellular telephone industry, cellular telephones have proven to be a very useful tool to communicate with others. With advances in smartphone technology, modern cellular telephone devices are increasingly being used as replacements for laptop and desktop computers. Because of applications like Web browsing, watching videos, photography and playing games, the display sizes of smartphones have become very large. Some of the newest smartphones have displays measuring more than 6 inches diagonally. However, some users may find that phones of this size may be difficult or impossible to carry in a user's pocket or small purse.

Although small portable devices intended to perform some functionality of a smartphone device exist, such devices lack a proper user interface that may provide a user with a touchscreen experience fulfilled only by a modern day smartphone cellular device. Users are becoming increasingly dependent on their smartphones, using them instead of laptop and desktop computers, while forgoing landline telephones.

### SUMMARY OF THE DESCRIPTION

The present invention relates to a smartphone capable of providing a user with the basic functionality of a smartphone without the bulk and size of a modern day smartphone cellular device. In one embodiment the cellular telephone comprises a front surface and a back surface. In another embodiment the cellular telephone comprises a front surface, a back surface, and a rim surface connecting the front surface with the back surface. In one embodiment, the cellular telephone has no external physical buttons and no external physical switches and input is received through a touchscreen interface that receives the user's inputs. In another embodiment user input can also be provided by shaking or moving the cellular telephone in a prescribed manner. Gestures (on the touchscreen or by physically moving/shaking the cellular telephone) can be used to change between modes, such as a cellular telephone voice call mode, a text messaging (SMS) modem or an email mode, etc. The absence of external physical buttons and external physical switches, in an embodiment, means that there is no external physical button and no external physical switch that the user can press, depress, lower, slide, push, or otherwise interact with to change the state of operation (or mode) of the cellular telephone. The touchscreen is not considered or defined to be a physical button or physical switch for the purposes of this description. However, this does not preclude the presence of an internal physical button. For example, in another embodiment, the cellular telephone can have an internal physical button (e.g., inside the cellular telephone and accessible when the device is physically opened to reset the telephone). In this embodiment, the internal physical button can be programmed to perform various functions, including, but not limited to, administrative functions related to the device (e.g., factory reset, flash bios, etc.).

As it pertains to this invention, interacting with a touchscreen, coupling a cable with the cellular telephone, or otherwise coupling the cellular telephone to a base unit/charging unit does not constitute pressing, depressing, lowering, sliding, pushing or otherwise interacting with the state of operation (or mode) using an external physical button or an external physical switch located on the cellular telephone. In one embodiment, all operations pertaining to changing the state or mode of the cellular telephone can be performed based on specific motions or gestures on the touchscreen or by moving/shaking the device in a prescribed manner. In another embodiment, a piezoelectric generator can be used to allow a user to turn on the device by shaking or moving it in a prescribed manner and in this embodiment the cellular telephone has no external physical buttons and no external physical switches to operate the device. In one embodiment the cellular telephone can include a sensory system that is capable of placing the device in a charging mode, optionally disabling the cellular telephone transceiver and deregistering the device from a cellular network, when the device is coupled to a base unit or otherwise connected with a cable directly. The sensory system can also place the device in an active mode when decoupled from, for example, a base unit or a charging cable, optionally turning on the cellular telephone transceiver and registering with the cellular network. In one embodiment such a sensory system can comprise proximity sensors, voltage sensors, or other sensors that can detect the placement on, or removal from, a base unit/charging cable capable of charging the cellular telephone.

In another embodiment the cellular telephone can be placed in an inactive mode where only a limited number of components of the cellular telephone are powered up, thus limiting the power consumption of the cellular telephone. In yet another embodiment the cellular telephone can include an off mode where the cellular telephone exists in a state where the cellular device is powered off, that is, no power is being drawn. In one embodiment, the cellular telephone modes described above (but not limited to) are included in a power mode configuration. In yet another embodiment, any of the power mode configurations can be set based on shaking or moving the cellular telephone in a prescribed manner, or by specific gestures on the touchscreen panel.

In another embodiment, the cellular telephone includes a charging mechanism, which charges the cellular telephone battery using an inductive charging mechanism. The cellular telephone can be designed to attach magnetically to a base unit that inductively charges a rechargeable battery in the cellular telephone. In such an embodiment the cellular device can include at least one permanent magnet (or ferromagnetic material) that is designed to attract a permanent magnet in the base unit to hold the cellular telephone against the base unit while inductively charging the cellular telephone. The base unit includes a charger to inductively provide a charging signal to the inductive charging circuitry in the cellular telephone. In another implementation, the charging signal from the base unit can be introduced into the cellular telephone by charging pins or pads on the cellular telephone which mate with corresponding pins or pads on the base unit. In yet another embodiment the base unit comprises a cable that is connected to a power source (an AC or DC power source using an adaptor, or another electronic device like a laptop, etc.).

A base unit of a cellular telephone, as it pertains to the present invention, can comprise a base unit (or cradle) or any other mechanism through which the cellular telephone can receive a charging signal (including, but not limited to, a data cable, a DC adapter, an AC adapter, a transformer, etc.). The base unit, as it pertains to the present invention, can also be a charging cable capable of transmitting a charge/signal to charge the cellular telephone battery. In other embodiments the base unit can also transmit a data signal to and from the cellular telephone.

In one implementation the charging circuitry in the cellular telephone can be coupled to an inductive data transfer mechanism which can transmit and receive data (e.g., synchronize contact information, calendar information, email, music, etc.) between the cellular telephone and an electronic device coupled to the charging base unit. In yet another implementation, the data transfer mechanism or the charging mechanism can be introduced using a port located on the cellular telephone. Another embodiment can have no port located on the cellular telephone.

Any of the cellular telephone charging mechanisms described above can also be used to detect placement on, or removal from, a base unit, thus allowing switching between the charging and the active modes automatically. In yet another embodiment a proximity sensor can be used to detect the placement on, or removal from, the base unit, thus allowing switching between the charging mode and the active mode automatically. Further, in another embodiment, a voltage sensor located inside the cellular telephone or base unit can be used to detect the placement on (or removal from) the base unit. In yet another embodiment, said placement or removal can be indirectly sensed using another component or electrical circuit inside the cellular telephone or inside the base unit (e.g., using the state, condition, or voltage, of another component/electrical circuit).

Other embodiments can include the cellular telephone being substantially cylindrical in shape. Yet, other embodiments can include a screw-on mechanism and an O-ring gasket to attach the front surface of the cellular telephone with a back surface; the O-ring gasket provides a good seal against water. Such an embodiment can be waterproof. In one embodiment, a cellular telephone can have an internal frame that defines a substantially cylindrical shape in at least one cross sectional volume through the frame inside the cellular telephone, and a screw-on mechanism can be implemented in that portion of the frame; the cellular telephone can have an external cylindrical shape or can have a different external shape (e.g., rectangular) but still use such a screw-on mechanism. A cellular telephone which uses a screw on mechanism can include (1) a front portion which includes a display on a front surface and includes at least one first screw thread along a first cylindrical wall; and (2) a second portion having a back surface, the second portion having at least a second screw thread along a second cylindrical wall. The second screw thread is designed and sized to match the first screw thread such that the second screw thread matingly screws into the first screw thread. The first screw thread can be a first helical or spiral ridge along the first cylindrical wall and the second screw thread can be a second helical or spiral ridge along the second cylindrical wall. The cellular telephone can also include an O-ring gasket disposed between the first portion and the second portion to seal the joint between these portions and can also be of a water barrier material in one or more regions or surfaces or other joints in order to make the cellular telephone waterproof.

Numerous other embodiments can include other functionality (individually or a combination thereof), such as, being able to communicate with other electronic devices in a low powered mode using a Personal Area Network technology device (e.g., Bluetooth), or having a headset jack to transmit audible sound signals from the cellular telephone device, or having a camera and integrated flash system, Bluetooth, WiFi, near field communication, etc.

In one embodiment the cellular telephone can be a small cylindrical device with a diameter between 2 and 2.5 inches, and a depth (thickness) of 0.2 and 0.5 inches. This embodiment allows the cellular telephone to be comfortably carried in the smallest pant pockets or purse, or worn on the body by attaching it to a wrist strap, armband, lanyard, clip or fastener, yet have a touchscreen large enough to provide a virtual keyboard that allows typing with the same (or almost the same) speed, accuracy, and comfort of smartphones.

In another embodiment, the cellular telephone can also comprise a battery monitoring system, which can monitor the state of the power capacity of a battery in the cellular telephone. The battery monitoring system, upon determining a prescribed state of the power capacity of the battery, can automatically set the cellular telephone into an active mode (where the cellular transceiver is powered up and the cellular telephone can communicated over a cellular network), if not already set, and send a notification about the state of the battery to a designated destination using the cellular network. In one embodiment, the cellular telephone has an ear speaker on the rim surface. In one embodiment, the ear speaker is only on the rim surface and the microphone is also only on the rim surface.

In yet another embodiment, the cellular telephone (described in, but not limited to, any embodiment above) can also operate as a secondary cellular telephone where the cellular telephone shares the same number as that of a primary cellular telephone which, in one embodiment, can be the user's smartphone that is considerably bigger than the secondary cellular telephone. In one embodiment, the user can configure the secondary cellular device to operate in a seamless-interplay configuration with the primary cellular telephone such that the cellular network can be instructed to transmit all network communication to either the primary cellular telephone, the secondary cellular telephone, or both the primary and secondary cellular telephone, depending on whether or not the secondary cellular telephone is coupled to its base unit. If the secondary cellular telephone is coupled to the base unit, the primary cellular telephone will have cellular network communication (e.g., calls, text messages, etc.) directed to it (and nOt to the secondary cellular telephone). However, if the secondary cellular telephone is not coupled with the base unit then all cellular network communication is directed to at least the secondary cellular telephone (and optionally also to the primary cellular telephone). In one embodiment, the removal of the secondary cellular telephone from the base unit automatically activates the secondary cellular telephone on the network such that it can communicate via a cellular network and communications are automatically directed to the secondary cellular telephone in response to merely removing it from the base unit. In another embodiment, the secondary cellular telephone can communicate via the cellular network only when it is set in an active mode (disclosed above and elsewhere in this document).

The above summary does not include an exhaustive list of all aspects of the present invention. It is contemplated that the invention includes all systems and methods that can be practiced from all suitable combinations of the various aspects summarized above, and also those disclosed in the detailed description below.

### BRIEF DESCRIPTION OF THE DRAWINGS

The present invention is illustrated by way of example and not limitation in the figures of the accompanying drawings in which like references indicate similar elements.

FIG. 1A shows the front view of a cellular telephone, in one embodiment, comprising no external physical buttons and no external physical switches; FIG. 1B displays the back view of the cellular telephone; FIG. 1C displays a prospective side view of the cellular telephone.

FIGS. 2A and 2B are schematic diagrams of different embodiments of a cellular telephone displaying, as blocks, various modules and components that can be in any embodiment.

FIG. 3A is a flow diagram of a method of an embodiment of a cellular telephone describing a system in which the cellular telephone can either be charged via a base/charging unit, or can be charged and transfer data between the cellular telephone and an electronic device. FIG. 3B shows a flow diagram of an embodiment of the cellular telephone describing the state of the cellular telephone in the charging mode and the active mode.

FIG. 4A shows the flow diagram of a method of an embodiment of a cellular telephone describing the change of power mode configuration from the off mode to the active and inactive modes. FIG. 4B shows the flow diagram of a method of an embodiment of a cellular telephone in which the cellular telephone describing the different states of the power mode configuration of this embodiment.

FIG. 5 shows another embodiment of a cellular telephone displaying charging pins or pads to charge the cellular telephone. In this embodiment the cellular telephone can optionally have ferromagnetic contacts that can couple with magnetic contacts on the base unit or cable.

FIG. 6 shows an embodiment of a cellular telephone charging and data transfer system using induction.

FIG. 7 shows an embodiment of a corresponding base unit to charge and/or transfer data with the embodiment of the cellular telephone shown in FIG. 6.

FIG. 8 shows an embodiment of the cellular telephone and corresponding base unit system capable to charging and transfer data using an induction mechanism.

FIG. 9 shows an embodiment of a method flow diagram of a data transfer using an induction mechanism.

FIG. 10 shows an embodiment of the induction charging and data transfer mechanism that can be used in an embodiment of the cellular telephone and corresponding base unit system.

FIG. 11 shows an embodiment of the cellular telephone with a magnetically attached connector that can be used to power the unit, to transmit and receive data from the unit to a host device, and/or to magnetically connect a headset.

FIG. 12 shows an embodiment of the cellular telephone with an integrated camera and flash.

FIG. 13A shows an embodiment where the cellular telephone is used as a secondary cellular telephone, where the secondary cellular telephone is between 2.0 and 2.5 inches in diameter, and has a thickness between 0.2 and 0.5 inches. FIG. 13B shows the perspective back view of the embodiment shown in FIG. 13A. FIG. 13C shows the approximate alphanumeric key size along with the vertical and horizontal pitch of the buttons of a virtual keyboard used in the embodiment shown in FIG. 13A.

FIG. 14A shows a smartphone being used as a primary cellular telephone and FIG. 14B shows the cellular telephone being used as a secondary telephone sharing the same number with the primary telephone as shown in FIG. 14A.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment. The processes depicted in the figures that follow are performed by processing logic that comprises hardware (e.g., circuitry, dedicated logic, etc.), software, or a combination of both. Although the processes are described below in terms of some sequential operations, it should be appreciated that some of the operations described can be performed in a different order. Moreover, some operations can be performed in parallel rather than sequentially.

FIGS. 1A, 1B, and 1C show an embodiment of a cellular telephone comprising a housing, including a front surface 102, and a back surface 108. The front surface 102, in one embodiment, includes a touchscreen and a bezel 106 that surrounds the edge of the touchscreen. In another embodiment, the bezel 106 is an integral part of the front housing that also includes a side that can be referred to as a rim 106A.

In one embodiment, the back surface 108 can include a screw-on mechanism to secure the back surface 108 to the front housing. The housing, in different embodiments can be of multiple geometric shapes including, but not limited to, circular or a regular polygon. Thus, the front surface 102 and the back surface 108 can be any one of any geometric shape, including but not limited to, the geometrical shapes described above, or a combination thereof. In an alternative embodiment, the rim 106A can be an integral part of the back surface 108 such that the rim 106A and the back surface 108 are formed as one piece, and creates a cavity or compartment to store the electronics of the phone. In such an embodiment, the front surface 102 can include a touchscreen display (described later) while other electronic components are disposed in the cavity.

In the embodiment illustrated in FIGS. 1A, 1B, and 1C, the rim 106A includes one or more openings for an ear speaker 112 that generates audible sound waves (e.g., when having a conversation or listening to music, etc.). In one embodiment, the ear speaker 112 is on the rim 106A. As non-limiting examples, this can be advantageous to maximize the available touchscreen area and/or to reduce manufacturing costs by eliminating the need to having an opening in the touchscreen and/or display.

In another embodiment the speaker 112 also acts as a speaker that generates an audible notification (e.g., text message notification, new email notification, phone ringing when another person calls the user, etc). In another embodiment, the front surface 102 and the back surface 108 are connected using an O-ring seal, which serves as a gasket that can provide a watertight seal between the front surface 102 and the back surface 108.

In other embodiments there can be a joining rim or surface connecting the front and back surfaces. The joining surface can be a continuous single strip or comprising of at least one of multiple geometrical shapes of similar or different sizes joined together to form the joining surface.

The cellular telephone illustrated in the embodiment of in FIGS. 1A, 1B, and 1C, comprises a touchscreen display capable of receiving and processing touch inputs in one embodiment. In one embodiment the touchscreen display can receive multi-touch inputs. The touchscreen display is connected with the front surface 102 and functions as an input and output interface. A touch input panel (integrated with the display) provides the input functionality and the display provides the output functionality. The functionality of such an input and output interface can allow a user to perform various operations including, but not limited to, communicating with others via text (SMS) messaging, voice calling, installing software applications, performing requisite actions for software applications, or any other functionality that may be performed by a modern day smartphone cellular device with a touch-screen display (e.g., photography, viewing images, etc.).

In different embodiments, the touchscreen display could be of at least one of multiple geometric shapes and sizes. The touchscreen display can be continuous or can comprise multiple touch-screen display panels.

The cellular telephone, in one embodiment, does not comprise any external physical buttons or external physical switches. In this context the touchscreen is not considered as an external physical button or external physical switch. In other embodiments, the cellular telephone can also include a separate speaker that can be used to operate the ringer functionality. Optionally, the cellular telephone can also include a ‘vibrate’ mechanism.

FIGS. 2A and 2B show block diagrams of functional modules of different embodiments of the cellular telephone. It should be noted that various embodiments of the cellular telephone may or may not comprise various functional modules displayed in the figures. Further, various embodiments can include functional equivalents of any functional module. The blocks do not necessarily show one component in one block and can include multiple components in one block or a combination thereof, to perform functional equivalents of each block.

FIG. 2A shows an example of an embodiment of a secondary or primary cellular telephone 10 which does not include, in one implementation, any external physical buttons or external physical switches; rather, the touchscreen 26 acts as the only input device for cellular telephone 10 and there is no external physical on/off switch or button on the cellular telephone 10. The touchscreen 26 also acts as a visual output device, and can be a round display device on a face of the cellular telephone 10 which can have a cylindrical external shape. The cellular telephone 10 can also include a number of conventional components of a cellular telephone such as one or more radios 18 (such as a cellular telephone transceiver, a WiFi transceiver and a Bluetooth transceiver), one or more non-volatile memories 16 such as flash memory or other non-volatile semiconductor memories, system memory, such as DRAM (Dynamic Random Access Memory) 14, for storing data and computer program instructions to be executed by one or more processors such as one or more microprocessors 12, and optional sensors 22 (e.g., an ambient light sensor to control the intensity of the display's backlight) and one or more buses 20 that interconnect, using architectures known in the art, the microprocessor(s) 12, DRAM 14, the non-volatile memory 16, the radio(s) 18, and a conventional I/O controller 24 which controls the touchscreen 26. The one or more radios 18, the touchscreen 26, the one or more microprocessors 12, the DRAM 14, the one or more buses 20, and the non-volatile memory 16 can operate in the same manner as, with similar components as, a conventional smartphone with a touchscreen interface and also include the additional functionality of a secondary or primary cellular telephone that has a power on mechanism that operates (e.g., can be turned on from a completely off state) without any physical buttons or switches, and the power manager 32 and the set of one or more electrical generators can, in one embodiment, provide that power on mechanism.

The set of one or more electrical generators 28 and the power manager 32 and the set of one or more turn-on sensors 39 can provide a power on mechanism that can allow the cellular telephone 10 to be turned on (from a completely off state) without having any physical buttons or switches on the cellular telephone 10. When the cellular telephone 10 is completely off, the touchscreen 26 cannot detect any inputs, and the set of one or more microprocessors 12 is also off and cannot process any inputs. In one embodiment, the cellular telephone 10 can be turned on, from a completely off state or mode, through a method, shown in FIG. 4A, that uses this power on mechanism. The set of one or more electrical generators 28 can be piezoelectric generators (or piezoelectric accelerometers) that can be configured to generate an electrical voltage when the cellular telephone 10 is moved, such as when it is moved in a predetermined way (e.g., shaking the telephone 10 from left to right and back again, repeatedly over a period of a few seconds). The movement generates a voltage which can then be applied, either directly, or through an optional filter 30, to a low powered switch that is coupled to a start up input or pin of a power manager 32. The power manager 32 can be a low power (e.g., CMOS) microcontroller or a low power ASIC (Application Specific Integrated Circuit) that is designed or programmed to operate as described (e.g., as shown in FIG. 4A). For example, the power manager 32 can be a low power microcontroller that is programmed with an on-board ROM (read only memory) to operate as described to turn on and boot-up in response to a voltage from the set of one or more electrical generators 28 and then to execute the method shown in FIG. 4A; alternatively, the power manager 32 can be a low power (e.g., CMOS circuitry) ASIC that is configured to implement a state machine that executes the method of FIG. 4A in response to a sufficient voltage from the set of one or more electrical generators 28. The optional filter 30 can be a circuit that filters out short term or transitory pulses from the electrical generators such that these pulses do not cause the power manager 32 to turn on, but the optional filter 30 allows longer pulses (e.g., over several seconds such as 3 seconds) to turn on the power manager 32; the optional filter can be a set of capacitors that charge up over time as the telephone 10 is shaken over the several seconds and after a sufficient amount of time, the capacitors store enough charge to cause the low power switch to turn on which then causes the power manager 32 to turn on. An example of a low power switch that can, once it receives an activation voltage, turn on a processing system is provided in published U.S. patent application publication 2012/0313758. The optional filter 30 can prevent the power manager 32 from being turned on from transitory and incidental movement of the telephone 10 (such as when the telephone 10 is in a user's pocket and the telephone 10 moves as a result of the user's walking with the telephone 10 in the pocket). Once the power manager 32 is turned on by the low power switch, it receives power from battery 34 and it can keep itself on by driving a signal, under its control, to its power-on input or pin which can also receive the turn on signal from the low power switch. Once the power manager 32 is turned on, it can manage power consumption of the various components by controlling different power supply lines on a power bus that supplies power to various components in telephone 10. The different power supply lines in power bus 38 selectively (under the control of power manager 32) receives power from battery 34 (when switched on under the control of power manager 32) and supply power to the following components in one embodiment: turn-on sensors 39, battery monitor circuit 36, optional sensors 22, the one or more microprocessors 12, the DRAM 14, non-volatile memory 16, the one or more radios 18, the I/O controller 24 and the touchscreen 26. The power manager 32 controls the power supply to each of these components, in one embodiment, in accordance with the method shown in FIG. 4A. For example, in the inactive mode, in one embodiment, the power manager 32 supplies battery power, through selected lines of the power bus 38 to the turn-on sensors 39, itself and to the battery monitor circuit 36, and during the inactive mode the power manager 32 does not supply battery power to the touchscreen 26, I/O controller 24, radios 18, non-volatile memory 16, the volatile system memory (e.g., DRAM 14), the one or more microprocessors 12 and the optional sensors 22.

The turn-on sensors 39 can be a set of one or more accelerometers designed or configured to detect one or more predetermined motions of the telephone 10 in order to determine whether the motion of the telephone 10 indicates that the user wants to turn on the telephone 10. During the inactive mode, the turn-on sensors 39 receive power from battery 34 (via a supply line in power bus 38) and provide one or more outputs (indicating motion data or states) to the power manager 32 which then decides whether the telephone 10 is being moved in the one or more predetermined motions that indicate that other parts of the telephone 10 need to be powered up. The battery 34 can be a conventional small lithium ion battery that can fit in the cylindrical housing of one embodiment described herein of the telephone 10. The battery 34 provides power to the power manager 32 and provides power to the rest of the telephone through switches, controlled by power manager 32, that are coupled to the power bus 38. The battery monitor circuit 36 monitors the state of the battery 34 through its input that is coupled to battery 34 and provides an indication of the state (e.g., normal or low) of battery 34 to the power manager 32. The battery charger circuitry 40 can be a conventional battery charger that controls the charging of battery 34 and supplies the charging current to the battery 34. The battery charger circuitry 40 receives power for charging from a port 41 which can be any one of the connectors on the telephones described herein (such as pins or pads on the side surface of the telephone or an inductive charging coil). The battery charger circuitry 40 is also coupled to power manager 32 and provides a signal to the power manager 32; the signal indicates to the power manager 32 whether or not the telephone 10 is connected to the charging cable or charging base and based on that signal the power manager 32 can put the telephone 10 into a charging mode in which, in one embodiment, the one or more radios 18 are off (and not consuming power) while other components in the system (e.g., microprocessor 12, DRAM 14, optional sensors 22, non-volatile memory 16, I/O controller 24, touchscreen 26, power manager 32, battery monitor circuit 36, turn-on sensors 39, and battery charger circuitry 40) are on and are consuming power. One embodiment of a charging mode is described further in this disclosure.

One embodiment of a method for power management, which can be performed by power manager 32, is shown in FIG. 4A. This method can begin in operation 4A-1 in which the telephone 10 is not charging (and not connected to a charging base or a charging cable) and is in an off mode (with all electronics off and not consuming power in one embodiment). In operation 4A-3, a power manager (such as power manager 32 or other processing logic) can receive a wake up signal from a set of one or more electrical generators 28; in response to this wake up signal, the power manager in operation 4A-5 turns on (e.g., power manager 32 turns on and draws power from battery 34), and the power manager then turns on power for turn-on sensors (e.g., sensors 39) and turns on power for a battery monitoring circuit. In this way, the power manager can be caused to exit from the off mode and enter the inactive mode described herein. The telephone 10 can remain in the inactive mode for an extended period of time (e.g., a number of months) and can cycle through operations 4A-7, 4A-9, 4A-11 and back to 4A-7, etc. over that period of time. For example, after the telephone 10 has entered the inactive mode (e.g., from operations 4A-19 or 4A-25), the user may place the telephone 10 in a nightstand or a glove box of a car for an extended period of time, and the battery monitoring circuit can periodically and repeatedly check the battery's state in operation 4A-11. If the battery has a sufficient amount of power remaining, the telephone 10 can remain in the loop of 4A-7, 4A-9, 4A-11 until the power or charge remaining in the battery falls below a predetermined level at which point, in operation 4A-13, the power manager causes the rest of the system in telephone 10 to turn on and causes an alert (such as an email or text message or phone call) to be sent about the state of the battery (such as a reminder to charge the battery or replace the battery). After this alert is sent, the power manager can return the cellular telephone to the inactive mode. Subsequent alerts can be sent as the battery power diminishes over time. In another (not preferred) embodiment the system can automatically issue a shut down command to set the cellular telephone to the off mode (after one or more alerts, as described, have been sent).

Each time the power manager performs operation 4A-7, it checks the output(s) from the turn-on sensors, which can be a set of accelerometers that are designed or configured to detect one or more predetermined patterns of motion that a user can use to wake up other parts of the system of telephone 10. The power manager 32, for example, can be programmed or configured to recognize a sequence of outputs from the turn-on sensors 39 that indicate that the telephone 10 is being moved, over of a period of one or a few seconds, in a predetermined motion pattern (e.g., repeatedly up and down or repeatedly left and right, etc.). If the power manager determines that the predetermined motion pattern was not detected, then it leaves the telephone 10 in the inactive mode (in operation 4A-9) and checks the output of battery monitor circuitry 36 in operation 4A-11 and returns to operation 4A-7 if the battery is not low. On the other hand, if the power manager determines that the predetermined motion pattern was detected, then the power manager proceeds to operation 4A-15 in which it turns on power to other components in the system of telephone 10, such as the one or more microprocessors 12, optional sensors 22, DRAM 14, non-volatile memory 16, I/O controller 24 and touchscreen 26 (while the one or more radios 18 can remain in an off state, consuming no power). In one embodiment, the operation 4A-15 includes a boot-up operation of the microprocessor(s) 12 in which executable software and data is loaded from non-volatile memory 16 and the microprocessor(s) 12 boot up one or more operating systems into an initial, default state; in another embodiment, the operation 4A-15 can be a wake up from a hibernation state in which a prior operating state of the telephone 10 was saved into the non-volatile memory 16 and the microprocessor loads that prior operating state into the system of telephone 10. The prior operating state is normally the last state the user left the system in when the system went into inactive mode. After completing operation 4A-15, the system presents, in operation 4A-17, a wake up user interface (UI) on the touchscreen to determine whether the user wants to wake up the phone into the active mode. This UI can be a question such as “Turn On?” or “Wake Up?” or other messages asking whether the user wants to use the telephone 10. The UI can include conventional mechanisms, such as a swipe indicator or other UI suggesting to the user to swipe their finger in one or more directions across the touchscreen in a pattern to indicate to the system that the user wants to sue the telephone 10 or otherwise cause it to enter active mode. In operation 4A-19, the system processes inputs from the touch screen to determine the user's response to the wake up UI. If the system determines that the user has requested that the system wake up, then the system, in operation 4A-21, turns on the one or more radios (such as radio(s) 18) and the telephone 10 can now receive and make phone calls, send text messages, send emails, etc. now that the system of telephone 10 is in the active mode. Once in the active mode, the system of telephone 10 can perform conventional management in operation 4A-23 (for example, the microprocessor 12 can dim the backlight of the touchscreen or turn off that backlight in response to a period of user inactivity relative to the touchscreen). If the system of telephone 10 determines in operation 4A-19 that, after a period of time (e.g., 5 or 10 seconds), the user has not entered an input (such as a swipe or other gesture or entered a pass code), that indicates a user's request to wake up the system then the system can in one embodiment revert back to the inactive mode by returning to operation 4A-7 or, in another embodiment the system can perform a shut down and return to the off mode (4A-1). In the active mode, the user can, through one or more inputs on the touchscreen, cause the system of telephone 10 to be shut down (go into off mode—4A-1) or, in another embodiment, the user can, through one or more inputs on the touchscreen, cause the system to go into the inactive mode (and thereby revert to operation 4A-7).

In an alternative embodiment of the method of FIG. 4A, one or more portions of the set of one or more microprocessors 12 perform some or all of the functions of power manager 32 such that, for example, the electrical generators toggle (at operation 4A-3) a switch to turn on the more or more portions of the set of one or more microprocessors which, in turn, turn on the “turn-on sensors” and the battery monitoring circuit (at operation 4A-5) to enter the inactive mode. Then, the one or more portions can execute, in a repeated cycle, operations 4A-7, 4A-9, 4A-11, and 4A-13, until the turn-on sensors sense a wake up input, which can cause the one or more portions (after processing the outputs from the turn-on sensors) to perform operation 4A-15 (thereby powering up any unpowered portion of processors 12 and powering up the touchscreen and powering up (if not already powered up) the DRAM and flash memory).

FIG. 2B describes another embodiment of the cellular telephone. Referring to FIG. 2B, in one embodiment various functional modules (represented as blocks) can be connected via a bus 205 via module connector 206. The module connector can be any instrument capable of transmitting an electrical charge between the given modules in any embodiment. Thus, in this context, in any embodiment, another module could act as a module connector 206. Each module is able to connect to the bus 205 via module connector 206, the module connector 206 capable of transmitting bi-directionally or uni-directionally depending on the functionality of a given module. In an embodiment the cellular telephone can comprise the touchscreen display 212, processing system 208, a storage module 201 (which can be flash memory or other non-volatile semiconductor memory), a memory module 202 (which can be DRAM), and a battery & power circuitry 222, each connected with the bus 205. In one embodiment the cellular telephone can comprise a powering mechanism 215 coupled to the processing system 208 via the bus 205, where the powering mechanism is capable of powering the cellular telephone without the use of any physical buttons or switches. In another embodiment the powering mechanism can be coupled directly with the processing system transmitting the on or off signal via an activation pathway 204. Further, the processing system 208 can be coupled to the cellular telephone transceiver 214 (which provides cellular telephone 2-way radio functionality). In one embodiment, the processing system 208 can be configured to turn off the cellular telephone transceiver 214 and the processing system 208 after a period of inactivity of the cellular telephone.

In one embodiment the powering mechanism 215 can include at least one electrical generator 218, at least one motion sensor 220, and a processing logic 216. The electrical generator 218 can be coupled to the motion sensor 220 and the processing logic 216, directly or indirectly, via the motion sensor 220. In one embodiment the electrical generator 218 can be configured to generate electrical power for the motion sensor 220 and the processing logic 216 when the cellular telephone is off or substantially off. For example, if the cellular telephone has had no activity for a period of time (e.g., 2 hours), the processing system in one embodiment can completely turn off the cellular telephone transceiver and also turn off all other components in the cellular telephone. The electrical generator 218 can be configured to generate electrical power for the motion sensor 220 and the processing logic 216 when the cellular telephone is moved in a prescribed manner, even if all of the other components are completely off. Further, the motion sensor 220 and associated processing logic 216, once powered by the electrical generator, can be configured to wake up the processing system 208 from the off or substantially off state in response to the movement in the prescribed manner. This can be achieved by configuring the processing logic 216 to detect the movement in the prescribed manner based on signals from the motion sensor 218.

In another embodiment the powering mechanism 215 can comprise at least one piezoelectric accelerometer coupled to the processing logic 216, where the processing logic 216 is coupled to the processing system 208 to wake the processing system 208 from a power off state in response to signals from the piezoelectric accelerometer that indicate a prescribed pattern of movement. In one embodiment the prescribed pattern of movement can include a combination of any of the three possible axis (X, Y, and Z) and the three rotational axis of a three dimensional Cartesian coordinate system.

Another embodiment can comprise at least one sensory system 232, where the sensory system 232 is able to be set the cellular telephone in an active mode when the cellular telephone is removed from a base/charging unit, and further is able to set the cellular telephone in a charging mode, when the cellular telephone is coupled to the base/charging unit. These modes are further explained below while describing FIG. 4B. In one embodiment the sensory system 232 can be coupled to the processing system 208 where the processing system 208 is coupled to the cellular telephone transceiver 214. In one embodiment the processing system can turn on the cellular telephone transceiver 214 when the cellular telephone is in the active mode, and can turn off the cellular telephone transceiver 214 when the cellular telephone is in a charging mode.

In one embodiment the sensory system 232 can comprise at least one proximity sensor. In another embodiment the sensory system 232 can include at least one of a contact sensor, an infrared sensor, and a magnetic sensor.

In yet another embodiment the cellular telephone can be configured to be set into a low powered mode in which the cellular transceiver 214 can be turned off so that the cellular telephone ceases communication with a cellular network and enable a Personal Area Network Device 234. In this embodiment, the Personal Area Network Device 234 can be used to communicate with an electronic device that is also using a Personal Area Network technology device as a communicator. In one embodiment the Personal Area Network technology device can be one of a Bluetooth device, an IrDA device, a wireless USB device, a Z-Wave device and a ZigBee device. The electronic device can include a wearable sensor, like a heartbeat monitor, an accelerometer, a pedometer, or a skin temperature monitor. The Personal Area Network device 234 can connect with the electronic device and collect and display information on the cellular telephone. Such information can also be stored on the cellular telephone for further use or analysis.

In one such embodiment, the cellular telephone can connect with a heart-beat monitor using Bluetooth technology and monitor the user's heart rate. If the sensor detects an unusual heart rate, the cellular telephone can alert the user via a visual and/or audible/sensory alarm (ring or vibrate and display a warning message on the display). In another embodiment, the cellular telephone can deactivate the low powered mode by automatically enabling the cellular telephone transceiver 214 and dialing a preconfigured number (like 911) or transmitting a text (SMS) message to one or more preconfigured numbers.

In another implementation, under the low powered mode, the cellular telephone can also be used as an emergency device in which the cellular telephone can be preconfigured to enable the cellular telephone transceiver 214 (and thus deactivate the low powered mode) and dial a number (like 911) based on certain gestures on the cellular telephone touch screen display 212 or based on a movement of the cellular telephone recognized by the motion sensors 220 and/or processing logic 216. In an alternative configuration, when the cellular telephone is used as an emergency device, once the emergency call (like 911) is terminated, the cellular telephone can automatically set itself back to the low powered mode.

In another embodiment the cellular telephone can include a battery charging mechanism, using an inductive charging circuitry 230, which charges a battery of the cellular telephone. The inductive charging circuitry can include one or more coils 228 disposed near the back surface 108 to receive a charging signal, capable of charging the battery of the cellular telephone from a base unit. In one embodiment, the induction coils 228 can transmit the charging signal directly to the battery and powering circuitry which can charge the battery directly.

In another embodiment the induction coils 228 can convey a data and a charging signal and transmit it to a modulator/demodulator module 226 that can demodulate the data (e.g., synchronization data to synchronize contact and/or calendar information or software between the cellular telephone and another electronic device) and charging signal and transmit the signals to the data processing module 224 and battery & power circuitry 222 respectively. The modulator/demodulator 226 unit can also act as a transceiver, transmitting the data to and from the cellular telephone processing system 208 via the bus 205. The inductive data transfer mechanism is explained while describing FIGS. 6-10.

The above mentioned embodiments only describe a few possibilities and are not to be construed as a limiting factor. Other embodiments may describe some elements that can be connected directly to each other. Further, in other embodiments some modules, as shown in FIG. 2B, can be connected via the bus 205, and others can be directly connected to each other using a direct connector.

FIG. 3A shows a flow diagram of an embodiment of a cellular telephone describing a system in which a base/charging unit can either charge the cellular telephone, or can charge and transfer data between the cellular telephone and an electronic device. Operation 302 represents a state when the cellular telephone is coupled to a base/charging station. At 304, the cellular telephone processing system determines if an electronic device is coupled to the base/charging unit from where the cellular telephone can send or receive information. If it is determined at 304 that no such device is connected with the base/charging unit, then the processing system can instruct the battery charging circuitry to only charge the cellular telephone until the battery is full or the user removes the cellular telephone from the base/charging unit, as represented by operation 310. If however, the processing system determines at 304 that an electronic device is coupled to the base/charging unit, then the processing system performs an operation as represented by 308 and transfers (sends or receives) data (such as synchronization data) while charging the cellular telephone. Once the data transfer is complete, the cellular telephone continues to charge the battery unit until the user removes the cellular telephone from the base or the battery is fully charged, as presented by 310.

FIG. 3B shows a flow diagram of the cellular telephone, in one embodiment, when it is connected to a base station or charging cable as represent by 320. At 322 the cellular telephone detects a successful connection with the base unit or charging cable, and then sets the cellular telephone to a charging mode as shown in 324. In this embodiment, in the charging mode, the cellular telephone turns off all radios (e.g., the cellular telephone transceiver, WiFi, Bluetooth, etc., this is further described in detail when describing FIG. 4B. At 326, the cellular telephone battery is charged while a battery monitoring circuit continuously monitors that battery state (capacity). Also, in this embodiment, under the charging mode, the microprocessor is fully functional and various other components, like the touchscreen panel are also functional. In this embodiment, the cellular telephone acts like a stand alone computing device under the charging mode. At 328, if the cellular telephone is disconnected from the base or cable, the cellular telephone enters the active mode and the cellular transceiver is powered up, as shown at 330. If at 328, the cellular telephone is not disconnected from the base or cable, the cellular telephone keeps on charging the cellular telephone battery while monitoring its state, as represented by 324.

FIG. 4B shows a flow diagram of an embodiment of a cellular telephone in which the cellular telephone can set to an active mode and communicate with a cellular network, as well as can set to a charging mode where the cellular telephone disables communication with the cellular network. In one embodiment, in the charging mode, the cellular telephone acts as a stand alone computing device with a fully functional touchscreen panel and a fully powered microprocessor (and other associated components). The flow diagram also shows an embodiment of placing the cellular telephone in an active mode, an inactive mode, a charging mode, or an off mode.

For example, in one embodiment, these modes can be summarized as follows:

| Mode | Mode defined | How mode can be activated/set |
|---|---|---|
| Off mode | All electronics of the | 1. User turns off device by |
| | cellular telephone are | shutdown command on touch |
| | in off state, that is, | screen; |
| | the device is powered | 2. User performs a |
| | off. | predefined gesture on the |
| | | touchscreen; or |
| | | 3. System is configured, in |
| | | one embodiment, to |
| | | automatically shut down |
| | | after a predetermined period |
| | | of no activity; |
| Inactive | At least a battery | 1. User issues a sleep/ |
| mode | monitoring circuit to | inactive command on the |
| | monitor the current | touch screen; |
| | state of the battery is | 2. User performs a |
| | powered up (optionally, | predefined gesture (either |
| | the power manager and | on touchscreen or by |
| | certain other sensors | physically shaking/moving |
| | are also powered up). | device in a prescribed |
| | | manner); or |
| | | 3. System is configured to |
| | | automatically go into |
| | | inactive mode after a |
| | | predetermined period of no |
| | | activity. |
| Charging | Almost all components | 1. User couples the cellular |
| mode | of the cellular | telephone to the base unit |
| | telephone, with the | or a cable. |
| | exception of the | |
| | radio(s), are turned | |
| | on. | |
| | In this mode the | |
| | cellular telephone can | |
| | act as a stand alone | |
| | computing device. | |
| Active | All electronics are | 1. User decouples cellular |
| mode | fully functional, | telephone from the base unit |
| | including the radio(s). | or cable; |
| | Normal power | 2. User shakes/moves the |
| | management (display | device in a predetermined |
| | back light etc) is in | manner (and optionally, is |
| | place. | provided an option on the |
| | | touchscreen to swipe/provide |
| | | a certain gesture to enable |
| | | the active mode); or |
| | | 3. Battery monitoring |
| | | circuit automatically |
| | | activates system (into the |
| | | active mode) to send |
| | | notification about battery |
| | | state. |

Referring to FIG. 4B, at operation 402 the cellular telephone is set to the charging mode and is being charged as shown in FIG. 3B. In this mode, almost all electronics of the cellular telephone are powered up except for the radio(s) (e.g., Cellular telephone transceiver, Bluetooth, WiFi, etc.). In one embodiment, when the user removes the cellular telephone from the base unit, at operation 404, the cellular telephone is set to the active mode directly in response to the removal of the telephone from the base unit. In one embodiment, at operation 406, the user operates the cellular telephone (e.g., the user receives a phone call or initiates a call or sends an email or text message or views a calendar, etc.). In one embodiment, at operation 408, the processing system checks to see if the user has placed the cellular telephone back on the base station/base unit. If so, control is passed to operation 420 where the cellular telephone is returned to the charging mode. In one embodiment, at operation 408, if it is determined that the user has not placed the cellular telephone on the base unit, the processing system is configured to recognize specific patterns under which, if the cellular telephone is shaken or otherwise moved, the processing system is capable of setting the device into the inactive mode as shown at operation 410. In one embodiment, on receiving a prescribed movement or shake, shown at operation 414, the device can be placed into the inactive mode.

In another embodiment, in the off mode, all electronics of the cellular telephone are placed in the off state, and no power is drawn. In one embodiment, the off mode can be set when the user turns off the device by issuing a shutdown command on the touchscreen. In another embodiment, to set the off mode, the user performs a predefined gesture on the touchscreen. In yet another (not preferred) embodiment, to set the off mode, the system is configured to automatically shut down after a predetermined period of no activity (operation 413), and yet in another (not preferred) embodiment, the battery monitoring circuit, after sending a notification (or a series of notifications) about the battery state (capacity) to a designated destination, can automatically turn off the device.

In one embodiment, in the charging mode, all electronics of the cellular telephone are powered on, except for the radio(s) (e.g., cellular telephone transceiver, WiFi, Bluetooth, etc.). In another embodiment the cellular telephone can act as a stand alone computing device when set in the charging mode. In another embodiment, only the cellular network transceiver is disabled in the charging mode and the user can connect to other electronic devices or a network using the built-in WiFi (or Bluetooth) device while the device is placed in the charging mode. In one embodiment, the charging mode is set when the user couples the cellular telephone with a base unit/charging cable.

In one embodiment, in the active mode, all electronics/components of the cellular telephone are powered up and the cellular telephone is fully functional. In another embodiment, in the active mode, normal power management (e.g., dimming the screen when not in use for a predetermined period of time etc.), are in place during the active mode of operation. In one embodiment, the cellular telephone can be set into the active mode when the user decouples cellular telephone from the base unit or cable. In another embodiment, the active mode can be set when the user shakes/moves the device in a predetermined manner. In another embodiment, after shaking/moving the device in a predetermined manner the user is, optionally, provided with an option on the touchscreen to swipe/provide a certain gesture to enable the active mode. In yet another embodiment, the system can set into an active mode automatically by the battery monitoring circuit, when the battery monitoring circuit determines the battery state (capacity) at a certain predetermined value, and sets the cellular telephone into the active mode to send a notification about battery state to a designation destination over the cellular network.

In one embodiment, in the inactive mode almost all the components of the system can be powered off. In one embodiment, a battery monitoring circuitry/system is powered up in the inactive mode, and all other components are powered off. In one embodiment, when the system is instructed to set the cellular telephone into the inactive mode, the current state of the system is preserved by transferring the current state of the DRAM on to the flash/storage media. Conversely, when the system is returned back to the active mode, the system state is read from the storage media and placed back in the DRAM. In one embodiment, the inactive mode is set when the user issues a sleep/inactive command on the touch screen. In another embodiment the system is set to the inactive mode when the user performs a predefined gesture (either on touchscreen or by physically shaking/moving device in a prescribed manner). In yet another embodiment, the system can automatically set into the inactive mode if the system is configured to automatically go into inactive mode after a predetermined period of no activity.

In the charging mode, the cellular telephone can deregister from the cellular network. In another embodiment, the processing system can also be configured to automatically set in the off mode or the inactive mode (depending on the configuration) and reach operation 413, if there is no activity performed on the cellular telephone for a predetermined period of time (as determined by operation 412). This is useful to conserve the battery power when it is determined that the cellular telephone is not in use. In one embodiment, if at operation 412 it is determined that the cellular telephone has been used during the predetermined period, the cellular telephone remains in the active mode and the processing system returns to operation 406.

If the cellular telephone is set to the off or inactive mode at 413, the user can couple the cellular telephone with the base unit or charging cable, as represented by operation 416, and the cellular telephone can, in one embodiment, automatically set itself in the charging mode. Similarly, in one embodiment, if the user has moved the device in a prescribed manner to set it into the inactive mode (operation 410→operation 414), coupling the device to the base unit or charging cable would automatically set the cellular telephone into the charging mode (operation 416). In another embodiment, the cellular telephone can remain in the off or inactive mode (entered at operation 413/414), even after coupling the cellular telephone with the base unit or cable, until a user shakes, or otherwise moves, the cellular telephone in the prescribed manner. In one embodiment, if the user couples the cellular telephone with the base unit in the off or inactive mode (entered at operation 413/414), the cellular telephone and base unit/cable system can at least charging a battery in the cellular telephone, while the cellular telephone remains in the same state (i.e., the state remains in the off or inactive mode). In yet another embodiment, the cellular telephone can remain in the off or inactive mode (entered at operation 413/414) when coupled to the base unit/cable until the user removes the telephone from the base unit (or disconnects the cable). In another embodiment, the user can custom configure the power configuration modes (e.g., active mode, inactive mode, charging mode, off mode, etc.) of the cellular telephone by selectively determining the components of the cellular telephone to be powered on (or off) for a given mode.

Alternatively, the user may not place the cellular telephone on the base unit/connect a charging cable, and can instead manually shake, or otherwise move, the cellular telephone in a prescribed manner to set the cellular device in the active mode, as represented by operation 418. In this scenario, the processing system returns to operation 412 and the cycle is repeated over again.

FIG. 4B shows, in one embodiment, the cellular telephone device can switch between active, inactive, charging and the off modes without the use of any external physical buttons or switches. The device can be set to the active mode (from a charging mode) by removing it from the base unit/charging cable. The device can be turned on (from a substantially off, or completely off, state that was entered as a result of a period of inactivity as determined, for example, in operation 412) by moving the device in a prescribed manner (operation 418).

Using FIG. 2B as a non-limiting example, the movement in the prescribed manner can be detected by motion sensors (such as motion sensors 220 which, in one embodiment, can be a set of three or more piezoelectric accelerometers) and recognized as the proper (and appropriate) prescribed manner by processing logic 216 which can receive signals indicating motion in a variety of axis (for example, from a variety of accelerometers or motion sensors 220 configured to detect acceleration as movement in a set of axis). Once the processing logic 216 determines that the movement in the prescribed manner has occurred, the processing logic 216 can cause the processing system 208 to be turned on and the processing system 208 can then power up the rest of the cellular telephone. The processing logic 216 can be powered by the electrical generator 218 (which can be a set of piezoelectric accelerometers) and circuitry configured to generate a controlled voltage signal from the set of piezoelectric accelerometers to power the processing logic 216 when the rest of the cellular telephone is completely (or substantially) off; the motion sensors 220, if they need power, can also be powered by the electrical generators 218. The set of piezoelectric accelerometers in the electrical generator(s) 218 can be arranged so that the generators will provide enough power through each phase of movement that is part of the prescribed manner. For example, if the prescribed manner is, in sequence over a short period of time, such as about one second: (1) straight down-to→(2) up and left at an angle of about 45 degrees to→(3) right (and lastly)→(4) up and left at an angle of 45 degrees (to return to the original starting location) then one piezoelectric accelerometer, for movement in each orthogonal Cartesian 3D axis, can provide a set of at least three accelerometers that, at any one point in time, will be generating a voltage, from at least one of the accelerometers, that can be received and controlled in a voltage regulator circuit to generate the controlled voltage signal. Voltage multipliers and rectifiers can also be used to generate a sufficient controlled voltage signal from the outputs of the set of accelerometers. The processing logic 216 (which can be an ASIC gate array) can be configured to detect, over the same short period of time, the appropriate output signals from the motion sensors that indicate that the prescribed manner did occur.

Although various embodiments have been described above where the cellular telephone can be set into the off mode automatically (e.g., by the power manager, in some embodiments; after a period of inactivity, in some embodiments; etc.), in a preferred embodiment, the cellular telephone does not set itself in the off mode unless a command is issued by the user using the touchscreen (a swipe or certain gesture on the touchscreen) to set the cellular telephone to the off mode. In this case, the off mode can be entered only in response to a user command using the touchscreen, although an off mode could also occur if the battery fails or loses all of its charge.

FIG. 5 shows another embodiment of a cellular telephone which includes charging pins or pads to charge the cellular telephone. In this embodiment, the cellular telephone comprises a battery charging mechanism that charges a battery of the cellular telephone through one or more contact pins or pads 504 located on the cellular telephone. While FIG. 5 shows four pads 504, it will be appreciated that the cellular telephone can have a different number of pads 504 (such as 8 pads) and that these pads can also be used to transfer data to/from the cellular telephone (such as in a synchronization operation). The contact pins or pads 504 are capable of connecting with corresponding one or more contact pins or pads on a base/charging unit to charge the battery. These corresponding one or more contact pins or pads on the base unit can be spring-loaded pins, and in one such embodiment, matching contacts on the cellular telephone are represented as contact pins or pads 504. In another embodiment, holding or coupling pads 502, made of ferromagnetic material (e.g., steel), can be placed surrounding contact pads 504. The ferromagnetic pads 502 can connect to magnetic bodies located near the contact pins on a base unit or cable to couple (or mate) the cellular telephone with base unit or cable. In yet another embodiment, the ferromagnetic contact pads 502 can be arranged in a circular manner and the corresponding magnetic body on the base unit/cable is arranged accordingly. In another embodiment, only one ferromagnetic pad 502 is arranged in a ring shape using a ferromagnetic material, along with a corresponding ring magnetic on the base unit/cable couples with ferromagnetic pad 502. In yet another embodiment multiple ferromagnetic pads 502 form a ring like structure, and corresponding magnetic bodies are provided on the base unit/cable to couple with the ferromagnetic pads 502. In any embodiment, the contact pads/pins 504 and corresponding pins or pads on the base unit (if present) are arranged as such that a connection between the contact pins/pads is established when the ferromagnetic pad 502 mate with the corresponding magnetic body on the base unit/cable.

In one embodiment, the contact pad 504 has a completely smooth exterior, with no indentations or protuberances. This is advantageous because such a configuration can provide a charging/data transfer mechanism, while preserving the waterproof capabilities of the device, if otherwise provided by the embodiment. In another embodiment, the speaker holes 112 and the microphone hole 110 are backed with a waterproof membrane (e.g., membranes made by WL Gore). Such a membrane would selectively allow audible sound waves to penetrate the membrane, while disallowing water to penetrate.

In another embodiment the cellular telephone can enclose ferromagnetic inserts which mate with corresponding magnets in the base unit. In this embodiment, no magnets are placed in the cellular telephone reducing the possibility of degaussing credit cards etc., that can inadvertently come in contact with the cellular telephone (e.g., when in the users pocket, purse, etc.). In another embodiment, a cable with magnetic bodies can be used to charge the cellular telephone. In one embodiment a magnet is located on the end of the cable. A plurality of spring loaded pins are provided between the magnets. The cable can be a USB power/data cable, or a headset cable through which the user can hear audible sound signals transmitted from the cellular telephone. In an alternative embodiment, the headset cable, when coupled with the cellular telephone, can also be used by a user to speak through a microphone located on the headset cable.

In another embodiment, the battery charging mechanism that charges the battery of the cellular telephone can utilize a port located on the cellular telephone. Such a port would be capable of connecting with a corresponding port on a base/charging unit capable of transmitting a charging signal from the base unit to the cellular telephone. In an alternative embodiment, no ports or jacks are present on the external surface of the cellular telephone. In yet an alternative embodiment, any connector on the external surface of the cellular telephone is covered or encased within a water barrier material such that the cellular telephone is waterproof.

FIGS. 6-10 show various embodiments of a system comprising the cellular telephone and a base unit comprising a data transfer mechanism using an induction. The data transfer mechanism can transmit and receive a data signal between the cellular telephone and an electronic device. FIG. 6 displays an embodiment of a cellular telephone charging and data transfer system using induction. It comprises an inductive circuitry having one or more coils 618 disposed near the back surface 602 of the cellular telephone. The inductive circuitry is capable of transferring the data signal to and from a modulator/demodulator module unit 606 located in the cellular telephone. The modulator/demodulator module unit 606 can also comprise a transceiver. The modulator/demodulator module 606 can demodulate a charging and data signal (in case of receiving a signal). The demodulator of the modulator/demodulator unit 606 can transmit the demodulated data signal to the data processing module 610 (further explained while describing FIG. 10) and the charging signal to the battery charging module 608. The modulator/demodulator unit 606 can also modulate a transport signal and a data signal to be transmitted to an electronic device that is coupled with, directly or indirectly, the base unit. This aspect is further explained while describing FIGS. 8 and 9.

In one embodiment the cellular telephone can also have at least one permanent magnet 604 which is capable of attracting a corresponding magnet in a base unit of opposite polarity so as to couple the cellular telephone with the base unit while charging and/or transferring data. Other embodiments of the cellular telephone can contain a magnet-less coupling system. Yet other embodiments of the cellular telephone can comprise a non-magnetic material disc as further described while explaining FIG. 8.

FIG. 7 shows an embodiment of a corresponding base unit to charge and/or transfer data with the embodiment of the cellular telephone shown in FIG. 6. In this embodiment, corresponding induction coils 706 are capable of transmitting a charging and/or a data signal to the cellular telephone device shown in FIG. 1 or 6, for example. In another embodiment the corresponding induction coils 706 can also receive a data signal from the induction coils 618 of FIG. 6. The base unit has a charging surface 702. In one embodiment, the base unit comprises at least one opposite polarity permanent magnet 704 to couple with the cellular device. In another embodiment, the cellular telephone can attach to the base unit with a non-magnetic mechanical attachment system. The base unit has the capability to connect with a power source 716 and a power input module 712 which can transmit a charging signal for charging the cellular telephone. The base unit can have a connector 714 to transmit data from a smartphone or another electronic device which can transmit the data signal to the data processing module 710 (further explained describing FIG. 10). The connector 714 coupling the electronic device with the base unit can be a physical data cable connector using a physical cable (such as a USB cable), a connector connecting one or more networks, or a wireless device (such as Wi-Fi transceivers) capable of connecting with a computer network.

The modulator/demodulator transceiver unit 708 can receive the data signal from the data processing module 710 and the charging signal from the power input module 712 and can modulate the signal and transmit it to the cellular device using the induction coils 706. In an alternative embodiment, the induction coils can receive a data signal from the cellular device, demodulating the signal at the modulator/demodulator transceiver unit 708 and transmitting the data signal to the data processing module 710 from where the signal can be transmitted to the electronic device coupled to the base station via connector 714. In this way synchronization data can be communicated between the cellular telephone shown in FIG. 1 or 6 (or as described herein) and another electronic device, such as a user's smartphone which could be the primary cellular telephone (in case the cellular telephone is used as a secondary cellular telephone, as further discussed herein).

FIG. 8 displays an embodiment of the cellular telephone and corresponding base unit system capable of charging and transferring data using an induction mechanism. In this embodiment the charging surface 806 of the base unit is coupled to the back surface 802 of the cellular telephone device using the attractive forces of opposite poles of permanent magnets 604 near the back surface of the cellular telephone and the permanent magnets 704 of the base unit. In one embodiment the cellular telephone can have at least one permanent magnet 604 projecting a pole (e.g., North) towards the back surface 602 capable of attracting with a corresponding magnet in the base unit with an opposite polarity (e.g., South) towards the charging surface 806. The magnets can be arranged in any fashion as long as the opposite poles of the permanent magnets in the base unit and the cellular telephone respectively are capable of attracting each other to couple the cellular telephone with the base unit. In other embodiments the cellular telephone can comprise at least one magnet attracting material or metal disc (e.g., steel) in lieu of a permanent magnet aligned with a permanent magnet 704 of the base unit. In another embodiment, the cellular telephone can attach to the base unit with a non-magnetic mechanical attachment system. In one embodiment, once coupled to the base unit the cellular telephone can be set into a charging mode and can be set to an active mode when decoupled with the base unit, as already discussed herein. While coupled to the base unit, the base unit can be connected with a power source 810 using a power adapter 808 and charge the cellular telephone.

In one implementation, the cellular telephone and base unit system can include a data transfer mechanism capable of transmitting a data and charging signal, from an electronic device to the cellular device, through the base unit via an induction data transfer mechanism. The inductive data transfer mechanism can include an inductive circuitry having one or more coils 618 disposed near the back surface of the cellular telephone and can transfer a data signal and a charging signal, to the cellular telephone, from the corresponding inductive coils 706 of the base unit using the modulator/demodulator transceiver unit 708. When the cellular telephone is coupled to the base unit and the base unit is coupled to an electronic device 812, the data signal from the electronic device 812 can be modulated with a charging signal at the modulator/demodulator transceiver 708, and can be transmitted to the corresponding inductive coils 706. The corresponding inductive coils 706 can transfer the signal to the inductive coils 618 from where the signal can be demodulated by the modulator/demodulator transceiver 606 of the cellular telephone.

Further, in another embodiment, if the cellular telephone recognizes data has been updated, or new information is available on the cellular telephone, it can instruct the base unit to temporarily cease sending a charging and data signal. The base unit can then place itself in a low powered receiving mode. The cellular telephone can then, using its own battery source, generate a transport signal and couple the transport signal with the data signal to its induction coils 618 using the modulator/demodulator transceiver unit 606. The transport signal can be powerful enough to transmit the data signal to the base unit using the induction mechanism already described above. In this way, no more battery is used than required while transmitting the data signal to the base unit. Once the base unit receives the data signal, the signal is demodulated by the modulator/demodulator transceiver 708 from where it is transmitted to the data processing unit 710. The signal can then be transmitted to the attached electronic device 812 through connector 714. The data processing unit of the cellular telephone 610 and the corresponding data processing unit 710 located in the base unit can also be used to check the integrity of the data sent or received. After the data is successfully transferred the base unit can disable the low powered receiving mode, and return back to its standard operational mode.

An embodiment of the above described data transfer induction mechanism has been shown as a method flow chart in FIG. 9. In operation 902 the cellular telephone is coupled to the base unit, and an electronic device is connected with the base unit in any manner as already described above. At operation 904 the cellular telephone receives updated information from the electronic device using the data transfer induction mechanism. At operation 906 the cellular telephone is configured to check if it contains updated or new information not available with the electronic device. If such information exists, at operation 908 the cellular telephone instructs the base unit to cease transmitting a charge signal and the base unit sets itself into a low powered receiving mode. At 910 the cellular telephone, using its battery source generates a transport signal and couples it with the data signal. The transport signal is powerful enough to transmit the data signal to the base unit using the inductive charging mechanism. At 912 the modulated signal is transmitted to the base unit by transmitting it across the cellular telephone's induction coils from where it is received by the corresponding induction coils in the base unit. The base unit then demodulates the signal and transfers the data signal to its data processing unit from where the data is transferred to the electronic device. At operation 914 the cellular telephone instructs the base unit to terminate the low powered receiving mode and at operation 916 the base unit charges the cellular telephone. Alternately, if at operation 906 it is determined that no new or updated information is available by the cellular telephone, the base/charging unit continues to charge the cellular telephone as shown at operation 916. In another embodiment, the charging and data transfer mechanism explained above can occur simultaneously.

Referring to FIG. 10, in one embodiment, data from (or to) the electronic device 1002 can be received from, or transmitted to, the data processing module 1004. The data processing module 1004 can assemble the data signal from the modulator/demodulator transceiver 1006 or can verify the data integrity received from, or transmitted to, the modulator/demodulator transceiver 1006. In other embodiments the data processing module 1004 can be used to transform the data signal to be sent to the modulator/demodulator transceiver 1006. The modulator/demodulator transceiver 1006 also receives an AC signal 1005 which can be received directly from the power source, or alternatively can be converted from a DC source available to the base using a power adapter connected to a mains AC source. The induction coils 1008 and 1010 transfer the signal between the base and the cellular telephone. If the signal is transmitted from the base unit, the Modulator/Demodulator transceiver 1012 can demodulate the signal and transmit the charging signal 1014 to a battery using the battery charging mechanism, and can also transmit the data signal to the data processing module 1016 from where the signal can be transmitted to the processing system 1018 of the cellular telephone. The data processing module 1016 and modulator/demodulator transceiver 1012 can operate similarly as 1004 and 1006 are explained above respectively. Thus, if the data signal is to be transmitted to the attached electronic device 1002 from the processing system 1018, the data processing module 1016 and the modulator/demodulator unit 1012 can perform in a corresponding manner, depending on the embodiment, as already described above.

FIG. 11 displays an embodiment of the cellular telephone with a magnetically attached connector 1102 which can be used to power the unit, to transmit and receive data from the unit to a host device, and/or to connect a headset.

FIG. 12 displays an embodiment of the cellular telephone with an integrated camera 1202 and flash 1204. In one embodiment the cellular telephone can comprise a camera 1202 disposed through a camera opening on the housing 1206 of the cellular telephone. In another embodiment the camera can be accompanied with a flash 1204 disposed through a flash opening located on housing 1206.

In another embodiment the back surface 108 of housing 1206 can comprise a screw-on mechanism (not shown) using an O-ring as a gasket. Such a screw-on mechanism is useful to prevent water from entering the cellular telephone by creating a seal. The screw-on mechanism can be used to screw-open and screw-close the cellular telephone to access the battery, SIM card, etc. In yet another embodiment the cellular telephone is substantially cylindrical.

Referring to FIGS. 13A and 13B, in one embodiment the cellular telephone can include a housing including a circular front surface 1302, a circular back surface 1308, and a bezel 1306 firmly holding the touchscreen in place. In one embodiment, the bezel 1306 and a rim 1306A are formed out of a single piece and forms a cavity or compartment to hold the electronics of the cellular telephone. The circular back surface 1308 has a diameter between 2 and 2.5 inches. The rim 1306A has a width between 0.2 and 0.5 inches and this is also the distance that separates the first surface 1302 from the back surface 1308. The touchscreen display, capable of receiving and processing touch inputs (or multi-touch inputs), is connected with the circular front surface 1302 and functions as an input and output interface. The touchscreen display has an exposed diameter between 1.6 inches and 2.2 inches and is surrounded by a support frame/bezel 1306. This embodiment also shows the placement of a speaker 1311 and a microphone 1309. It should be noted that the placement of speaker 1311 and microphone 1309 are shown as a non-limiting example, and can be placed anywhere on the housing.

As shown in FIG. 13C, the touchscreen display includes a virtual keyboard comprising virtual alphanumeric keys 1310 and virtual special keys 1312. The virtual alphanumeric keys 1310 have a length between 0.2 inches and 0.27 inches. Further, the virtual alphanumeric keys 1310 have a width between 0.14 and 0.19 inches. The horizontal key pitch (represented by H) is between 0.18 inches and 0.23 inches, and the vertical key pitch (represented by V) is between 0.24 inches and 0.36 inches.

### Secondary Cellular Telephone

The cellular telephone described in any of embodiments above can also be used as a secondary cellular telephone. A secondary cellular telephone is capable of sharing the same number as of a cellular telephone or smartphone device, referred as a primary cellular telephone herein. FIG. 14A displays a smartphone 1402 being used as a primary cellular telephone and FIG. 14B displays the cellular telephone being used as a secondary telephone 1404 sharing the same number with the primary telephone 1402 as shown in FIG. 14A. The primary cellular telephone 1402 and the secondary cellular telephone 1404 are subscribed with a cellular network and the secondary cellular telephone 1404 is capable of setting into an active mode in which the secondary cellular telephone 1404 can communicate with the network, and the secondary cellular telephone 1404 is capable of setting into a charging mode in which the secondary cellular telephone 1404 can disable communication with the network.

In one embodiment, the user can configure the secondary cellular telephone 1404 to operate in a seamless-interplay configuration with the primary cellular telephone 1402 such that the cellular network can be instructed to transmit all network communication to either the primary cellular telephone 1402, the secondary cellular telephone 1404, or both the primary cellular telephone 1402 and secondary cellular telephone 1404, depending on whether or not the secondary cellular telephone 1404 is attached to its base unit. If the secondary cellular telephone 1404 is attached to the base unit, the primary cellular telephone 1402 will have all cellular network communication (calls, text messages, etc.) directed to it (and not to the secondary cellular telephone 1404). However, if the secondary cellular telephone 1404 is not attached to the base unit then the secondary cellular telephone 1404 will have all cellular network communication directed to at least the secondary cellular telephone 1404 (and optionally also to the primary cellular telephone 1402).

In one embodiment, the removal of the secondary cellular telephone 1404 from the base unit automatically activates the secondary cellular telephone 1404 on the network so that it can communicate via a cellular network and communications are automatically directed to the secondary cellular telephone 1404 in response to merely removing it from the base unit. Any of the above described embodiments of the cellular telephone (described throughout this document) can also be used as a secondary cellular telephone, encompassing any individual feature of any embodiment, or a combination thereof.

In one embodiment the secondary cellular telephone 1404 can comprise a non-transitory computer readable medium that provides executable instructions for a seamless-interplay configuration which when processed by the secondary cellular telephone 1404 can instruct the cellular network to direct all cellular network communication to either the primary cellular telephone 1402, the secondary cellular telephone 1404, or both the primary cellular telephone 1402 and secondary cellular telephone 1404.

In the foregoing specification, the invention has been described with reference to specific exemplary embodiments thereof. It will be evident that various modifications can be made thereto without departing from the broader spirit and scope of the invention as set forth in the following claims. The specification and drawings are, accordingly, to be regarded in an illustrative sense rather than a restrictive sense.

What is claimed is:

1. A cellular telephone comprising:
a housing, including a front surface, a back surface; and
a touchscreen display capable of receiving and processing touch inputs, wherein the touchscreen display is connected with the front surface and functions as an input and output interface;
wherein the cellular telephone has no external physical buttons and the cellular telephone has no external physical switches.

2. The cellular telephone of claim 1, wherein the touchscreen is capable of receiving and processing multi-touch inputs and the cellular telephone further comprising:
a processing logic, wherein the processing logic can process and execute a plurality of instructions and the processing logic can instruct other circuitry in the cellular telephone to perform various actions based on any of the plurality of instructions or a combination thereof;
a battery monitoring system coupled to the processing logic, wherein the battery monitoring system, when powered on, can inform the processing logic the state of the power capacity of a battery located in the cellular telephone, wherein the battery powers the cellular telephone;
a cellular telephone transceiver, wherein the cellular telephone transceiver when powered on can register the cellular telephone to a cellular network, and wherein the cellular telephone transceiver when powered off can deregister the cellular telephone from the cellular network; and
a power managing system coupled to the processing logic, wherein the powering managing system upon receiving an instruction from the processing logic can set the cellular telephone into a power mode configuration, the power mode configuration including:
(a) an active mode, wherein the cellular telephone transceiver is powered on and the battery monitoring system is powered on,
(b) an inactive mode, wherein the cellular telephone transceiver is powered off, and the battery monitoring system is powered on,
(c) a charging mode, wherein the cellular telephone transceiver is powered off, and the battery monitoring system is powered on, and
(d) an off mode, wherein the cellular telephone transceiver is powered off, and the battery monitoring system is powered off.

3. The cellular telephone of claim 1, wherein:
the battery monitoring system, upon determining a prescribed state of the power capacity of the battery, can automatically signal the processing logic to instruct the power managing system to set the cellular telephone into the active mode of the power mode configuration, and wherein the power managing system includes a set of switches and a power bus; and
wherein upon entering the active mode, the cellular telephone automatically sends a notification about the state of the battery to a designated destination through the cellular network.

4. The cellular telephone of claim 1, wherein:
the housing is at least one of a substantially cylindrical and a regular polygon having more than four sides.

5. The cellular telephone of claim 1, wherein:
the cellular telephone has no ports and the cellular telephone has no jacks.

6. A cellular telephone and base unit system comprising:
a secondary cellular telephone capable of connecting with a cellular network, sharing a common telephone number with a primary cellular telephone, wherein the primary cellular telephone and the secondary cellular telephone are subscribed with the cellular network,
and wherein the secondary cellular telephone includes a power mode configuration of at least an active mode and a charging mode, wherein the secondary cellular telephone can communicate with the cellular network when set to the active mode and the secondary cellular telephone can cease to communicate with the cellular network when set to the charging mode;
a base unit, wherein the base unit is at least one of a base unit of the cellular telephone and a charging cable, capable of charging a battery of the secondary cellular telephone, wherein the base unit provides a mechanism to couple with the secondary cellular telephone and the secondary cellular telephone includes a sensor configured to detect the coupling and decoupling of the secondary cellular telephone with the base unit;
wherein the secondary cellular telephone automatically sets to the charging mode when coupled to the base unit and the secondary cellular telephone automatically sets to the active mode when decoupled with the base unit.

7. The cellular telephone and base unit system of claim 6, wherein the secondary cellular telephone comprises:
a housing, including a front surface and a back surface; and
a touchscreen display capable of receiving and processing touch inputs;
wherein the secondary cellular telephone has no external physical buttons and the secondary cellular telephone has no external physical switches.

8. The cellular telephone and base unit system of claim 7, wherein the housing is at least one of a substantially cylindrical and a regular polygon having more than four sides.

9. The cellular telephone and base unit system of claim 6, wherein the secondary cellular telephone further comprises:
a processing logic, wherein the processing logic can process and execute a plurality of instructions and the processing logic can instruct other circuitry in the secondary cellular telephone to perform various actions based on any of the plurality of instructions or a combination thereof;
a battery monitoring system coupled to the processing logic, wherein the battery monitoring system, when powered on, can inform the processing logic the state of the power capacity of a battery located in the secondary cellular telephone, wherein the battery powers the secondary cellular telephone;
a cellular telephone transceiver, wherein the cellular telephone transceiver when powered on can register the cellular telephone to a cellular network, and wherein the cellular telephone transceiver when powered off can deregister the cellular telephone from the cellular network; and
a power managing system coupled to the processing logic, wherein the powering managing system upon receiving an instruction from the processing logic can set the cellular telephone into one of the power mode configuration, wherein the power mode configuration further includes:
(a) an inactive mode, wherein the cellular telephone transceiver is powered off, and the battery monitoring system is powered on, and
(b) an off mode, wherein the cellular telephone transceiver is powered off, and the battery monitoring system is powered off,
and wherein the power mode configuration of the active mode powers on the cellular telephone transceiver and the battery monitoring system, and wherein the power mode configuration of the charging mode powers off the cellular telephone transceiver and powers on the battery monitoring system.

10. The cellular telephone and base unit system of claim 9, wherein:
the battery monitoring system, upon determining a prescribed state of the power capacity of the battery, can automatically signal the processing logic to instruct the power managing system to set the secondary cellular telephone into the active mode of the power mode configuration, and wherein the power managing system includes a set of switches and a power bus; and
wherein upon entering the active mode, the secondary cellular telephone automatically sends a notification about the state of the battery to a designated destination through the cellular network.

11. The cellular telephone and base unit system of claim 6, wherein:
the secondary cellular telephone has no ports and the secondary cellular telephone has no jacks.

12. A cellular telephone system comprising:
a secondary cellular telephone capable of connecting with a cellular network, sharing a common telephone number with a primary cellular telephone, wherein the primary cellular telephone and the secondary cellular telephone are subscribed with the cellular network;
wherein the secondary cellular telephone includes a battery monitoring system, wherein the battery monitoring system, upon determining a prescribed state of the power capacity of the battery, causes the secondary cellular telephone to automatically send a notification about the state of the battery to a designated destination through the cellular network.

13. The cellular telephone system of claim 12, wherein:
the secondary cellular telephone includes a power mode configuration of at least an active mode and an inactive mode, wherein the secondary cellular telephone can communicate with the cellular network when set to the active mode and the secondary cellular telephone can cease to communicate with the cellular network when set to the charging mode.

14. The cellular telephone system of claim 13, wherein:
the battery monitoring system can automatically set the secondary cellular telephone from the inactive mode to the active mode of the power mode configuration.

15. The cellular telephone system of claim 12, wherein the secondary cellular telephone further comprises:
a non-transitory computer readable medium that provides executable instructions for a seamless-interplay configuration which when processed by the secondary cellular telephone can instruct the cellular network to direct all cellular network communication to one of the primary cellular telephone, the secondary cellular telephone, and the primary cellular telephone and the secondary cellular telephone.

16. The cellular telephone system of claim 12, wherein the secondary cellular telephone comprises:
a housing, including a front surface and a back surface; and
a touchscreen display capable of receiving and processing touch inputs;
wherein the secondary cellular telephone has no external physical buttons and the secondary cellular telephone has no external physical switches.

17. The cellular telephone system of claim 16, wherein the housing is at least one of a substantially cylindrical and a regular polygon having more than four sides.

18. A cellular telephone comprising:
a radio transceiver;
a battery; and
a battery monitoring system coupled to the battery and coupled to the radio transceiver, wherein the battery monitoring system, upon determining a prescribed state of the power capacity of the battery, causes the radio transceiver to automatically send a notification about the state of the battery to a designated destination through a cellular network.
